(19) United States
(12) Patent Application Publication
(10) Pub. No.: US 2009/0166931 A1
(43) Pub. Date: Jul. 2, 2009

(54) PROCESS FOR MANUFACTURING KEYPAD MODULES OF NON-BACKLIGHTED PANELS

(76) Inventors: Chang-Li Liu, Gueishan (TW); Che-Tung Wu, Gueishan (TW)

Correspondence Address: HDLS Patent & Trademark Services, P.O. BOX 220746, CHANTILLY, VA, 20153-0746, US

(21) Appl. No.: 12/037,235

(22) Filed: Feb. 26, 2008

(30) Foreign Application Priority Data
Jan. 2, 2008 (TW) 097100078

(51) Int. Cl. B29C 45/16

(52) U.S. Cl. 264/447

(57) ABSTRACT

A manufacturing process for a keypad module includes the steps of: providing an opaque layer, one side of the opaque layer having symbol regions; providing a mold formed thereon with a planar recession and a plurality of pits for forming keys; injecting a gel-like ultraviolet curable resin into the planar recession and pits of the mold; adhering the surface of the opaque layer having the symbol regions on the planar recession of the mold so as to contact the ultraviolet curable resin; irradiating the mold with an ultraviolet light so as to cure the ultraviolet curable resin; and taking out the opaque layer and the cured ultraviolet curable resin to obtain a keypad module.

### BACKGROUND OF THE INVENTION

1. Field of the Invention

The present invention relates to a method for manufacturing a keypad, and in particular to a process for manufacturing a keypad module without backlight.

2. Description of Prior Art

A keypad assembly is one of the primary input devices for an electronic device. The surface of each key of the keypad assembly is provided with distinct numerals, characters, phonetic symbols, roots for an input method and/or various functional icons, so that a user can input required data or perform various functions of the electronic device. Therefore, for an electronic device, the keypad assembly acts as an important human/machine interface.

Since the light may be sometimes insufficient for a working environment of an electronic device, the keypad panel is usually provided with a light source to generate light for symbol, so that the user can still operate the keypad panel even though the light is dim. However, not all of the electronic devices may encounter the problem that the light in the surrounding environment is insufficient during an operation. Therefore, it is an important issue to manufacture a keypad module that can provide accurate locations of each key and a good touching sense for the keypad modules without backlight.

### SUMMARY OF THE INVENTION

The present invention is to provide a process for manufacturing a keypad module, which can be applied to a non-backlighted panel. An ultraviolet curable resin is used to form each key of the keypad module, thereby the touching sense of the user can be improved. Thus, the user can recognize whether he/she has completed the pressing action according to the touch feeling.

The present invention provides a process for a keypad module of a non-backlighted panel, which includes the steps of:

a) providing an opaque layer, one surface of the opaque layer having a symbol region;

b) providing a mold made of a light-transmissible material, the mold being formed thereon with a recessed planar recession and a plurality of pits;

c) injecting a gel-like ultraviolet curable resin into the planar recession and pits of the mold;

d) adhering the surface of the opaque layer having the symbol region on the planar recession of the mold so as to contact the gel-like ultraviolet curable resin;

e) irradiating the mold with an ultraviolet light so as to cure the ultraviolet curable resin and

f) taking out the opaque layer and the cured ultraviolet curable resin to obtain the keypad module.

### BRIEF DESCRIPTION OF THE DRAWINGS

FIG. 1 is a perspective view showing the keypad module manufactured according to the process of the present invention;

FIG. 2 is a cross-sectional view taken along the line 2-2 in FIG. 1;

FIG. 3 is flow chart showing the process of the present invention;

FIG. 4 is a perspective view showing the state before the opaque layer is disposed in the mold of the present invention;

FIG. 5 is a cross-sectional view showing the state after the opaque layer is disposed in the mold of the present invention;

FIG. 6 is a schematic view showing the ultraviolet curable resin in the mold of the present invention being cured by an ultraviolet light source;

FIG. 7 is a partially cross-sectional view showing the state after the keypad module manufactured according to the process of the present invention is integrated with a telecommunication device;

FIG. 8 is a schematic view showing the action of FIG. 7;

FIG. 9 is a schematic view showing the keypad module of the present invention being used in a mobile phone;

FIG. 10 is a schematic view showing the keypad module of the present invention being used in a personal digital assistant; and

FIG. 11 is a schematic view showing the keypad module of the present invention being used in an automobile control interface.

### DETAILED DESCRIPTION OF THE INVENTION

In order to make the Examiner to better understand the characteristics and technical contents of the present invention, a detailed description relating thereto will be made with reference to the accompanying drawings. However, the drawings are illustrative only, but not used to limit the scope of the present invention.

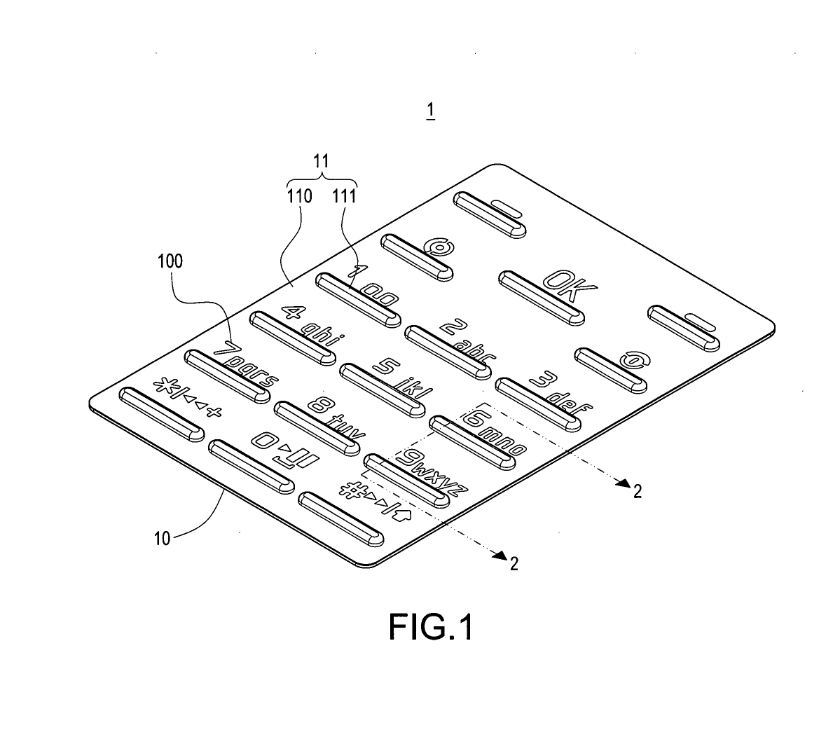

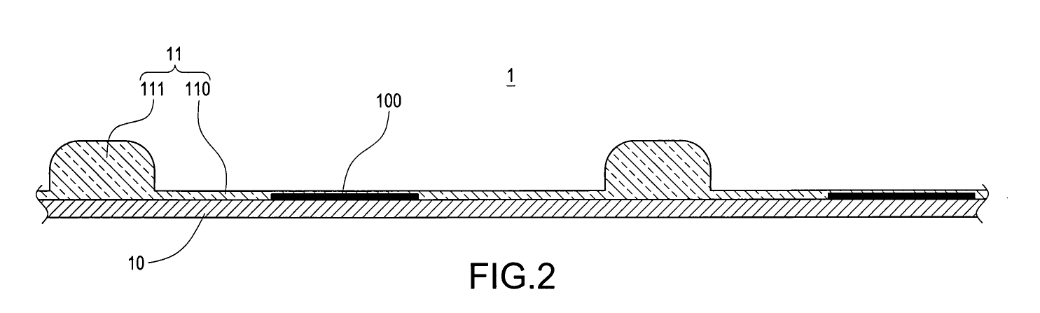

The present invention provides a process for manufacturing a keypad module of a non-backlighted panel. As shown in FIGS. 1 and 2, the keypad module 1 is composed of an opaque layer 10 and a key layer 11 overlapped with the opaque layer 10. The opaque layer 10 is a thin sheet made of an opaque material, such as a circuit board, wood, cork, leather, metal or the like. Via a printing, etching or an electronic ink developing process, one side of the opaque layer 10 is provided with a plurality of symbol regions 100 composed of various numerals, characters or symbols. The key layer 11 is attached on the side of the opaque layer 10 having the symbol regions 100. The key layer 11 has a base portion 110 that is adhered completely to the surface of the opaque layer 10, and a plurality of pressing portions 111 protruding from the base portion 110. Each of the pressing portions 111 is arranged to correspond to each of the symbol regions 100, respectively. As shown in the embodiment of the present invention, each of the pressing portions 111 is adjacent to the corresponding symbol region 100.

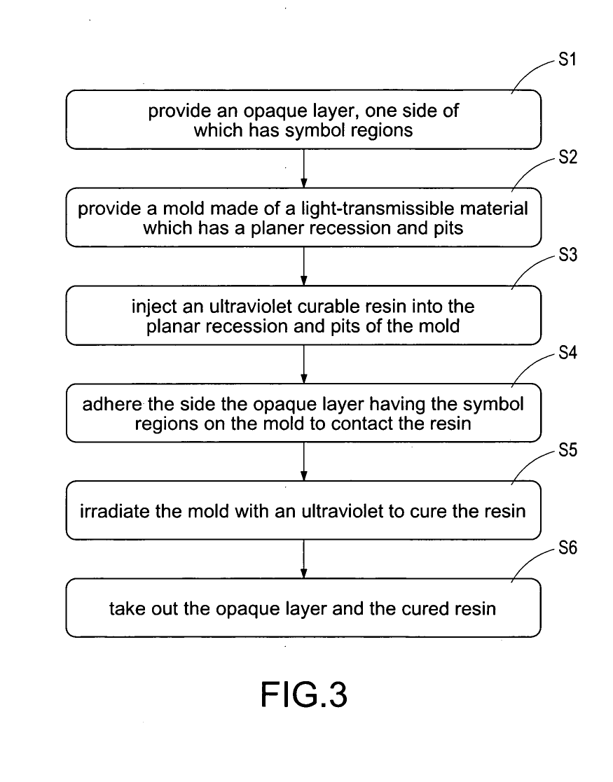

Please refer to FIG. 3 again. The keypad module 1 is manufactured by the process shown in FIG. 3. The opaque layer 10 and the key layer 11 of the keypad module 1 after being manufactured are adhered to each other to form a unit. The key layer 11 is made of an ultraviolet curable resin and thus has a light-transmissible property. After being adhered on the opaque layer 10, the symbol regions 100 can be still seen because of the light-transmissible property of the key layer 11. The process of the present invention will be described as follows.

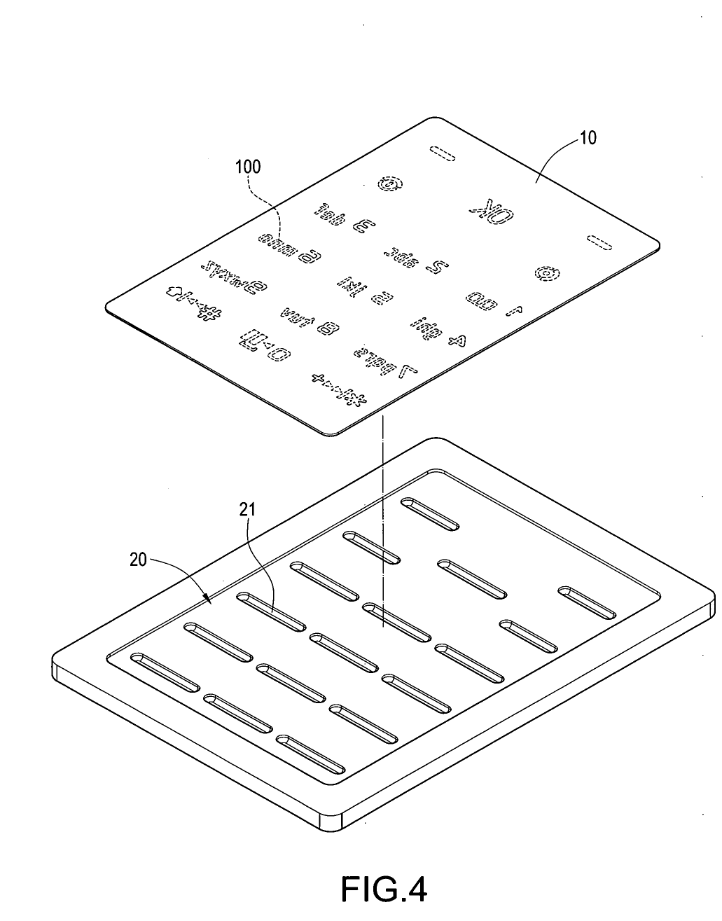

Please refer to FIGS. 3 and 4. First, the opaque layer 10 and the mold 2 for forming the key layer 11 are prepared in steps S1 and S2. The opaque layer 10 is formed thereon with a plurality of symbol regions 100. The mold 2 is made of a light-transmissible material, which allows the ultraviolet light to pass through. The mold 2 has a planar recession 20 for forming the key layer 11. In addition to form a base portion 110 of the key layer 11, the planar recession 20 also has a plurality of pits 21 for forming the pressing portions 111. It is worthy to mention that the order of the preparing steps for the opaque layer 10 and the mold 2 is not limited thereto. In other words, either of the opaque layer 10 and the mold 2 being prepared first is available. Of course, both the opaque layer and the mold can be prepared at the same time.

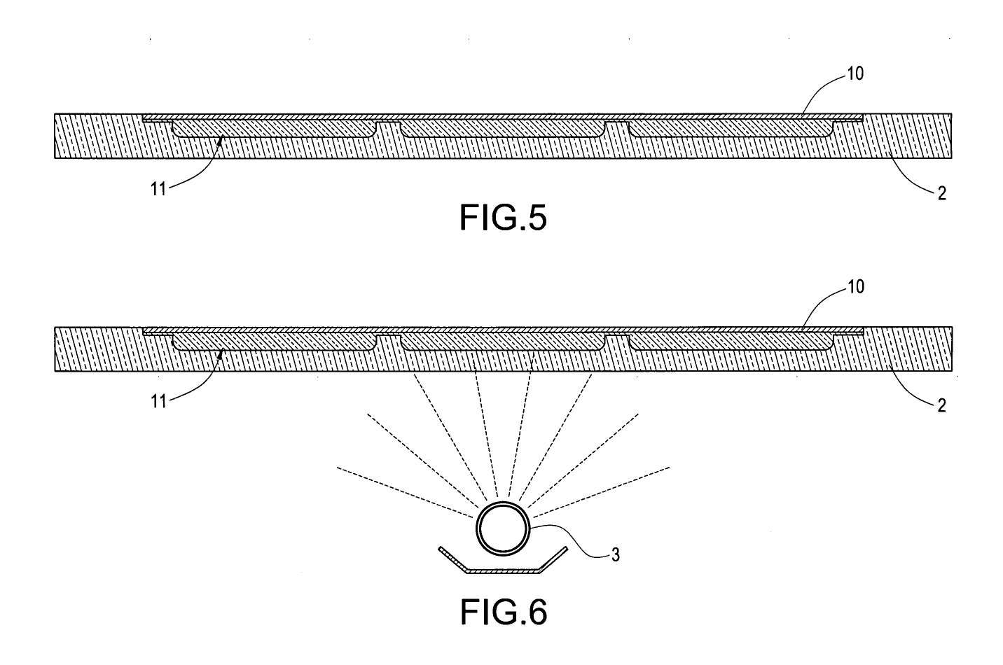

Please refer to FIGS. 3 and 5. A gel-like ultraviolet curable resin is injected into the planar recession 20 of the mold 2 in step S3. After all the pits 21 are filled with the resin and before the ultraviolet curable resin is cured completely, the surface of the opaque layer 10 on which the symbol regions 100 are provided is adhered on the planar recession 20 of the mold 2 so as to contact the gel-like ultraviolet curable resin in step S4.

Please refer to FIGS. 3 and 6. The mold 2 is irradiated with an ultraviolet light source 3 in step S5, thereby curing the ultraviolet curable resin injected into the planar recession 20 and pits 21 rapidly. After the resin is cured, the cured ultraviolet curable resin and the opaque layer 10 are taken out in step S6, thereby obtaining the keypad module 1.

Therefore, the above is the process for manufacturing a keypad module of a non-backlighted panel of the present invention.

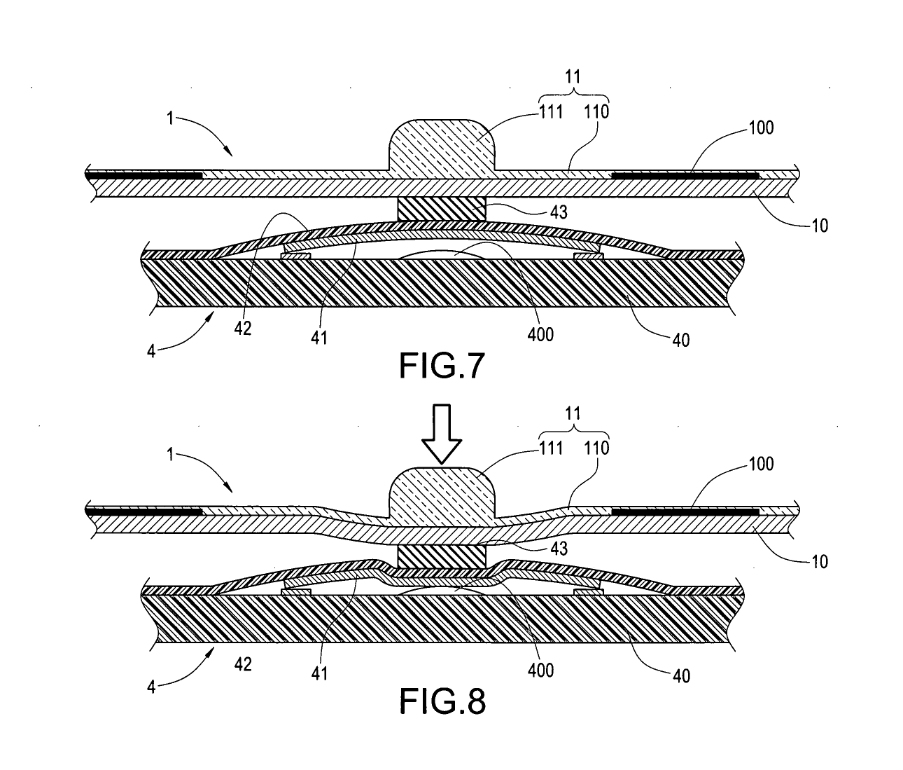

Please refer to FIG. 7. In practice, the keypad module 1 of the present invention can be integrated and cooperated with a telecommunication module 4. The telecommunication module 4 has a flexible printed circuit board 40. The circuit board 40 is provided thereon with a plurality of contacting points 400. Each of the contacting points 400 corresponds to each pressing portion 111 of the keypad module 1 in a vertical direction. Each of the contacting points 400 is provided thereon with a corresponding metal sheet 41. The circuit board 40 is provided thereon with an elastic film 42 for covering each metal sheet 41. A plurality of protrusions 43 is provided between the elastic film 42 and the keypad module 1. Each protrusion 43 corresponds to the underside of each pressing portion 111 of the keypad module 1.

Please refer to FIG. 8. When the user applies a downward force to press any pressing portion 111, the corresponding protrusion 43 is pressed to bias downwardly the elastic film 42 and the metal sheet 41 so as to touch the corresponding contacting point 400, thereby achieving an input action. In this way, the user can recognize the pressed location via each pressing portion 110 and thus obtain a touch feeling of pressing. Therefore, the user can judge whether the pressing action is completed or not via the touch feeling.

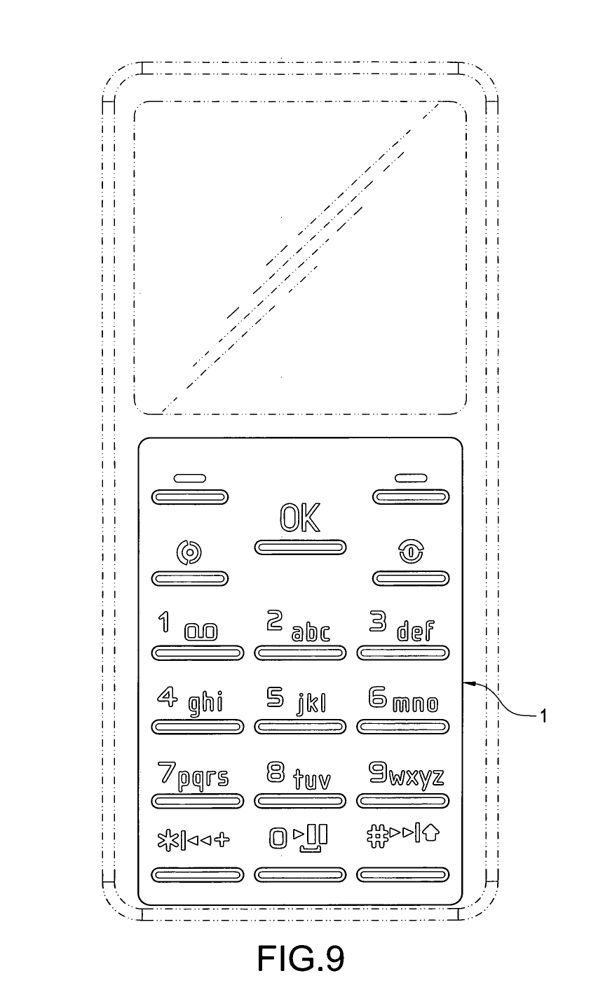

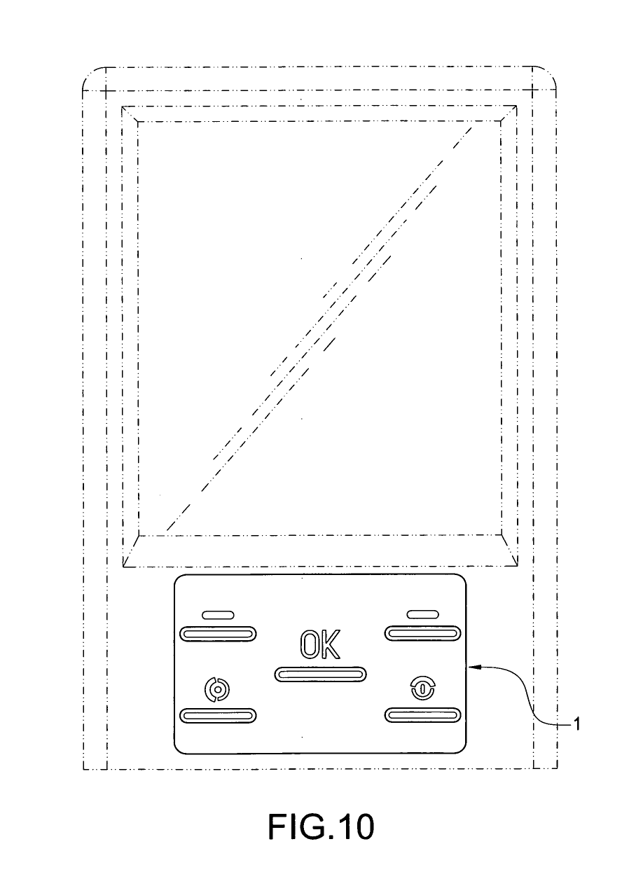

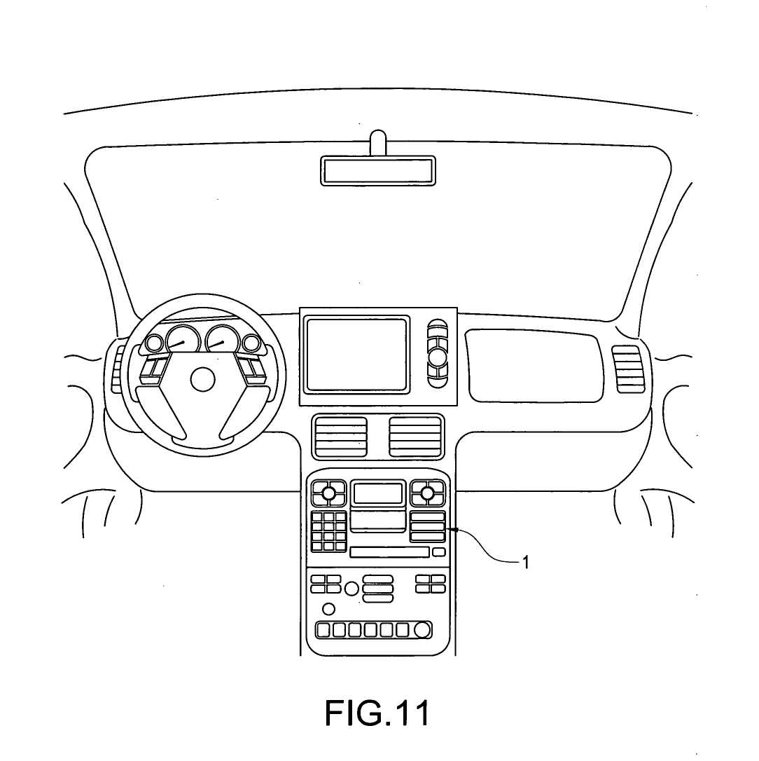

Further, please refer to FIGS. 9 to 11. The keypad module 1 of the present invention can be applied at least to a mobile phone, a personal digital assistant (PDA) and an automobile control interface. Of course, the application is not limited to the above cases and the present invention can be applied to other human/machine operating interfaces.

According to the above, the present invention really achieves the desired objects and solves the drawbacks of prior art. Further, the present invention has novelty and inventive steps, and thus conforms to the requirements for an invention patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A process for manufacturing a keypad module of a non-backlighted panel, comprising the steps of:
a) providing an opaque layer, one side of the opaque layer having a plurality of symbol regions;
b) providing a mold made of a light-transmissible material, the mold being formed thereon with a planar recession and a plurality of pits, thereby constituting keys;
c) injecting a gel-like ultraviolet curable resin into the planar recession and pits of the mold;
d) adhering the side of the opaque layer having the symbol regions on the planar recession of the mold so as to contact the gel-like ultraviolet curable resin;
e) irradiating the mold with an ultraviolet light so as to cure the ultraviolet curable resin rapidly; and
f) taking out the opaque layer and the cured ultraviolet curable resin.

2. The process according to claim 1, wherein the opaque layer prepared in the step a) is made of a circuit board, wood, cork, leather or metal.

3. The process according to claim 1, wherein the symbol regions is composed of numerals, characters or symbols.

4. The process according to claim 1, wherein the symbol regions mentioned in the step a) is provided on the opaque layer by means of a printing process.

5. The process according to claim 1, wherein the symbol regions mentioned in the step a) is provided on the opaque layer by means of an etching process.

6. The process according to claim 1, wherein the symbol regions mentioned in the step a) is developed on the opaque layer by means of electronic inks.

7. The process according to claim 1, wherein the steps a) and b) are performed at the same time.

8. The process according to claim 1, wherein the step b) is performed prior to the step a).
